(19) United States
(12) Patent Application Publication
(10) Pub. No.: US 2019/0204645 A1
(43) Pub. Date: Jul. 4, 2019

(54) BACKLIGHT ASSEMBLY AND LIQUID CRYSTAL DISPLAY DEVICE

(71) Applicants: BOE Technology Group Co., Ltd., Beijing (CN); Fuzhou BOE Optoelectronics Technology Co., Ltd., Fujian (CN)

(72) Inventors: Qi CHEN, Beijing (CN); Ming LI, Beijing (CN)

(21) Appl. No.: 16/119,411

(22) Filed: Aug. 31, 2018

(30) Foreign Application Priority Data
Jan. 2, 2018 (CN) 201810002280.8

(51) Int. Cl. G02F 1/1335

(52) U.S. Cl. CPC G02F 1/13362; G02F 1/133606; G02F 1/133608; G02F 2201/08; G02F 1/133617; G02F 2001/133567; G02F 2001/133614; G02F 1/133528

(57) ABSTRACT

A backlight assembly and a liquid crystal display device are provided. The backlight assembly includes a light source. The light source is configured to emit linearly polarized light polarized in a first direction.

### CROSS-REFERENCE TO RELATED APPLICATIONS

The present application claims the priority of Chinese Patent Application No. 201810002280.8, filed on Jan. 2, 2018, the contents of which are incorporated herein in their entirety by reference.

### TECHNICAL FIELD

The present disclosure relates to the field of display technology, and in particular, relates to a backlight assembly and a liquid crystal display device.

### BACKGROUND

With continuous development of the display technology, thin film transistor liquid crystal display (TFT-LCD) devices have become dominant products in the field of display due to their advantages of small size, low power consumption, no radiation, and the like. It is desirable to provide a backlight assembly and a liquid crystal display device each of which has better performance and a smaller size.

### SUMMARY

Embodiments of the present disclosure provide a backlight assembly and a liquid crystal display device.

Some embodiments of the present disclosure provide a backlight assembly including a light source, wherein the light source is configured to emit linearly polarized light polarized in a first direction.

In an embodiment, the light source includes a plurality of laser generators arranged in an array.

In an embodiment, the linearly polarized light is linearly polarized laser.

In an embodiment, the linearly polarized light emitted from the light source is monochromatic light.

In an embodiment, the backlight assembly further includes a diffractive optical element provided at a light outgoing side of the light source.

In an embodiment, a light outgoing surface of the diffractive optical element includes a micro-nano diffraction structure.

In an embodiment, a light incident surface of the diffractive optical element has a transmission enhanced layer provided thereon.

In an embodiment, each of the plurality of laser generators is a monochrome linearly polarized laser generator.

In an embodiment, the linearly polarized light emitted from the light source is monochrome linearly polarized laser.

In an embodiment, each of the plurality of laser generators is a blue linearly polarized laser generator.

In an embodiment, the linearly polarized light emitted from the light source is blue linearly polarized laser.

In an embodiment, the backlight assembly further includes a back cover and a support member, wherein the back cover includes a bottom plate and a sidewall, the light source is provided on the bottom plate, and the support member is provided on the sidewall and configured to support the diffractive optical element.

Some embodiments of the present disclosure provide a liquid crystal display device, which includes a backlight assembly and a liquid crystal display panel, wherein the backlight assembly is the backlight assembly provided by any one of the embodiments of the present disclosure.

In an embodiment, the liquid crystal display panel includes a first substrate and a second substrate arranged opposite to each other, the first substrate is at a side of the second substrate distal to the backlight assembly, and a liquid crystal layer is provided between the first substrate and the second substrate; and

the first substrate includes a polarizer.

In an embodiment, the first substrate further includes a color conversion layer provided at a side of the polarizer distal to the light source; and

the color conversion layer includes color conversion patterns configured to emit light of a color different from a color of the light emitted from the light source, under excitation by the light emitted from the light source.

In an embodiment, the liquid crystal display panel includes a plurality of pixel regions, and the color conversion patterns are provided in at least some of the plurality of pixel regions.

In an embodiment, the plurality of pixel regions include a first pixel region, a second pixel region, and a third pixel region;

the color conversion patterns include a first color conversion pattern and a second color conversion pattern;

the first color conversion pattern is provided in the first pixel region, and configured to emit first color light under excitation by the light emitted from the light source;

the second color conversion pattern is provided in the second pixel region, and configured to emit second color light under excitation by the light emitted from the light source; and

the light emitted from the light source is transmitted through the third pixel region without its wavelength being changed.

In an embodiment, the linearly polarized light emitted from the light source is blue light, the first pixel region is a red pixel region, the second pixel region is a green pixel region, and the third pixel region is a blue pixel region; and

the first color light is red light, and the second color light is green light.

In an embodiment, a material of the color conversion patterns includes at least one of an inorganic material containing a rare earth element, an organic fluorescent material, and a quantum dot material.

In an embodiment, the liquid crystal display device further includes light absorbing patterns provided at a side of the color conversion patterns distal to the light source, wherein the light absorbing patterns are configured to absorb the light emitted from the light source and transmitted through the color conversion patterns, whereas light converted by the color conversion patterns is transmitted through the light absorbing patterns.

### BRIEF DESCRIPTION OF THE DRAWINGS

FIG. 1 is a schematic diagram showing a structure of a liquid crystal display device according to an embodiment of the present disclosure;

FIG. 2 is a schematic diagram showing a structure of a backlight assembly according to an embodiment of the present disclosure;

FIG. 3 is a schematic diagram showing a comparison between light spots formed before and after a light beam passes through a diffractive optical element according to an embodiment of the present disclosure;

FIG. 4 is a schematic diagram showing a structure of another liquid crystal display device according to an embodiment of the present disclosure; and

FIG. 5 is a schematic diagram showing a comparison between a light transmittance of a display assembly of the liquid crystal display device shown in FIG. 4 and a light transmittance of a display assembly of the liquid crystal display device shown in FIG. 1.

### DETAILED DESCRIPTION

For better understanding of technical solutions of the present disclosure by one of ordinary skill in the art, a backlight assembly and a liquid crystal display device provided by embodiments of the present disclosure will be described in detail below with reference to the accompanying drawings.

FIG. 1 is a schematic diagram showing a structure of a liquid crystal display device according to an embodiment of the present disclosure. As shown in FIG. 1, the liquid crystal display device includes a backlight assembly and a liquid crystal display panel 3. The backlight assembly includes a back cover 7, and the back cover 7 includes a bottom plate 7A and sidewalls 7B. The backlight assembly further includes a light source 1 provided on the bottom plate 7A, a light guide plate (not shown) provided at a light outgoing side of the light source 1, and an optical film 2 (which generally includes a diffuser, a reflector, or the like) provided at a light outgoing side of the light guide plate. The liquid crystal display panel 3 includes a liquid crystal cell and polarizers 4 attached to two opposite sides of the liquid crystal cell. The polarizers 4 include a lower polarizer 4A (i.e., a polarizer proximal to the light source 1) and an upper polarizer 4B (i.e., a polarizer distal to the light source 1). The liquid crystal cell includes a first substrate 11 and a second substrate 12 arranged opposite to each other, and the first substrate 11 is at a side of the second substrate 12 distal to the backlight assembly (or distal to the light source 1). The liquid crystal cell further includes a liquid crystal layer 13 and a color filter layer 16 which are provided between the first substrate 11 and the second substrate 12, and the color filter layer 16 is provided at a light outgoing side of the liquid crystal layer 13. The liquid crystal layer 13 may be in contact with the second substrate 12, and the color filter layer 16 may be in contact with the first substrate 11. The liquid crystal cell further includes sealing blocks 17 provided at two opposite ends of the liquid crystal cell, respectively, between the first substrate 11 and the second substrate 12. The first substrate 11, the second substrate 12, and the sealing blocks 17 form a closed space accommodating the liquid crystal layer 13 and the color filter layer 16 therein, thereby forming the liquid crystal cell. The color filter layer 16 may include a plurality of pixel regions 18 (which may be pixels or sub-pixels) and a black matrix 19, and a grid line of the black matrix 19 separates any two adjacent ones of the pixel regions 18 from each other. The plurality of pixel regions 18 may include red (R) pixel regions, green (G) pixel regions, and blue (B) pixel regions. The light source 1 may include at least one light emitting diode (LED), and the at least one light emitting diode may be arranged in an array. The backlight assembly may further include a mold frame 8 and a bezel 9. The combination of the back cover 7, the mold frame 8 and the bezel 9 may assemble the remaining components as shown in FIG. 1 to form the liquid crystal display device. During operation of the liquid crystal display device, natural light emitted from the light source 1 is subjected to the action (e.g., diffusion, reflection, or the like) of the optical film 2, and then travels to the lower polarizer 4A. The lower polarizer 4A converts the natural light into linearly polarized light. After the linearly polarized light is subjected to the optical rotation effect of the liquid crystal layer 13, the polarization direction of the linearly polarized light is changed. Thereafter, the linearly polarized light is subjected to the filtering effects of the color filter layer 16 and the upper polarizer 4B, thereby displaying desired colors and brightnesses. A polarization direction of the upper polarizer 4B may be perpendicular to a polarization direction of the lower polarizer 4A, however, the present disclosure is not limited thereto.

In the liquid crystal display device as shown in FIG. 1, the polarizers 4 (i.e., the lower polarizer 4A and the upper polarizer 4B) are provided at both two opposite sides of the liquid crystal cell, respectively, and the optical film 2 is provided in the backlight assembly. Thus, an overall thickness of the liquid crystal display device is large, which is disadvantageous for achieving a lighter and thinner liquid crystal display device. Further, since both polarizers 4 will block and absorb light, the light transmittance of the liquid crystal display panel 3 is low, and improvement to the brightness thereof is limited. Furthermore, in the liquid crystal display device as shown in FIG. 1, in the case where chromatic display is achieved by using the filtering effect of the color filter layer 16, the three primary colors of R, G, and B may have poor monochromaticity, and it may be difficult to achieve the desired display effect of wide color gamut.

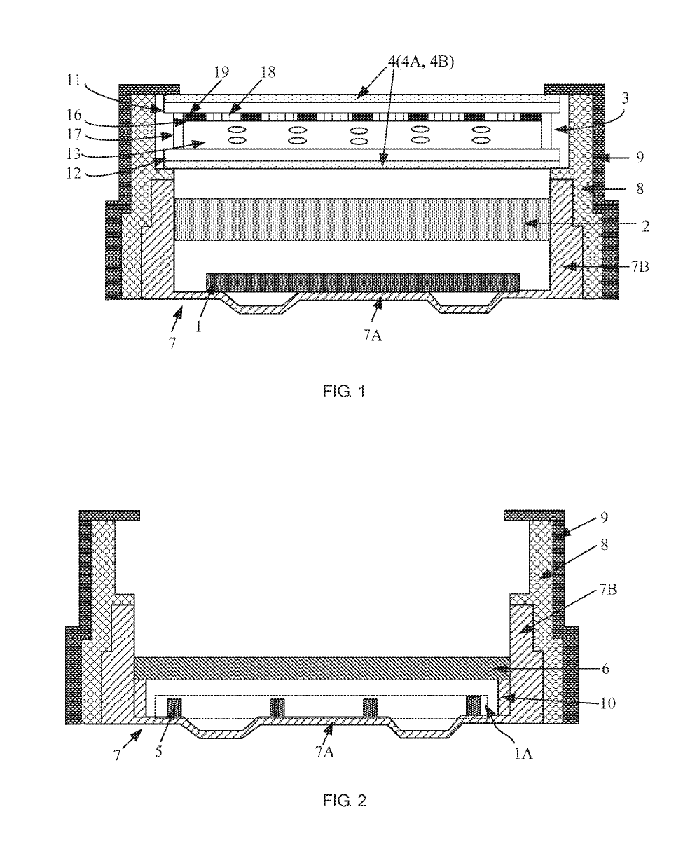

FIG. 2 is a schematic diagram showing a structure of a backlight assembly according to an embodiment of the present disclosure. As shown in FIG. 2, the backlight assembly includes a light source 1A configured to emit linearly polarized light. In an embodiment, the linearly polarized light may be polarized in a predetermined direction (e.g., a first direction). In an embodiment, the predetermined direction may be a direction parallel to the light outgoing surface of the light source 1A, and the light outgoing surface of the light source 1A may be a plane. In other words, the predetermined direction may be a direction perpendicular to a polarization direction of a polarizer of a display panel cooperating with the backlight assembly (e.g., a polarizer 44 of a liquid crystal display panel 33 as shown in FIG. 4). In an embodiment, the light source 1A emits monochrome linearly polarized light.

Compared with the backlight assembly of the liquid crystal display device shown in FIG. 1, the backlight assembly shown in FIG. 2 includes the light source 1A which directly emits the linearly polarized light polarized in the predetermined direction, and thus it is not necessary to provide a polarizer (e.g., the lower polarizer 4A shown in FIG. 1) at a side of a liquid crystal display panel cooperating with the backlight assembly (e.g., the liquid crystal display panel 33 as shown in FIG. 4) proximal to the light source 1A. As a result, a light transmittance of the liquid crystal display panel is increased effectively, and a thickness of the liquid crystal display panel is decreased. Further, a light guide plate and an optical film may be omitted from the backlight assembly shown in FIG. 2, thereby further decreasing the thickness of a liquid crystal display device including the backlight assembly, and further increasing the light transmittance of the liquid crystal display device.

In an embodiment, the light emitted from the light source 1A is linearly polarized laser. The linearly polarized laser has high energy and a high brightness, and thus can increase the overall display brightness of a liquid crystal display device including the backlight assembly. In an embodiment, the light source 1A includes a plurality of laser generators 5 arranged in an array. The plurality of laser generators 5 may be arranged uniformly so that both the uniformity and brightness of the light emitted from the light source 1A are increased effectively. In an embodiment, each of the laser generators 5 is a linearly polarized laser generator, and is configured to emit linearly polarized light (i.e., linearly polarized laser). In an embodiment, each of the laser generators 5 is a monochrome linearly polarized laser generator, and is configured to emit monochrome linearly polarized laser. In an embodiment, each of the laser generators 5 is a blue linearly polarized laser generator, and is configured to emit blue linearly polarized laser.

The inventors of the present disclosure found that, a light beam emitted from each of the laser generators 5 has a light spot (i.e., a pattern of a cross section of the light beam taken along a direction perpendicular to a propagation direction of the light beam) having a small size, and has a very small divergence angle. To make the light emitted from the backlight assembly uniform so that various regions of a liquid crystal display panel cooperating with the backlight assembly are illuminated by the light (i.e., laser), it is necessary to make a distance between any two adjacent ones of the laser generators 5 small and thus a large number of laser generators 5 may be required, which may cause the overall power consumption of the light source 1A to be large.

To decrease the number of the laser generators 5 required and the overall power consumption of the light source 1A, in an embodiment, a diffractive optical element (DOE) 6 is provided at the light outgoing side of the light source 1A, to shape and expand the light beam emitted from each of the laser generators 5. In other words, the diffractive optical element 6 is provided between the light source 1A and a liquid crystal display panel which is to cooperate with the backlight assembly, and is configured to shape and expand the light beam emitted from each of the laser generators 5. In an embodiment, the diffractive optical element 6 may be a diffractometer. In an embodiment, the light outgoing surface (i.e., the upper surface shown in FIG. 2) of the diffractive optical element 6 includes micro-nano diffraction structures for increasing the uniformity of light emitted from the diffractive optical element 6. For example, the micro-nano diffraction structures may be micro-nano protrusions, micro-nano recesses, or the like. In an embodiment, the light incident surface (i.e., the lower surface shown in FIG. 2) of the diffractive optical element 6 has a transmission enhanced layer provided thereon for increasing a light transmittance of the diffractive optical element 6.

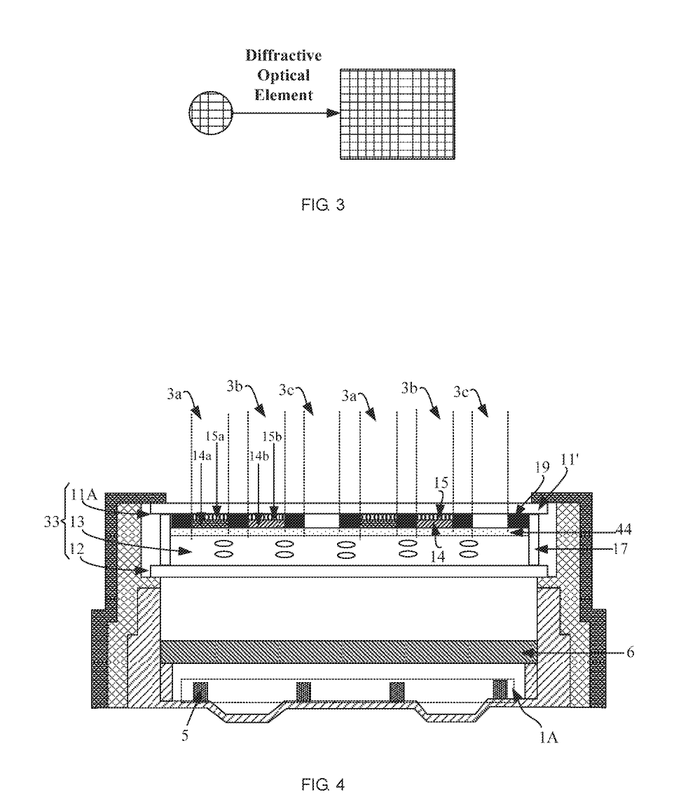

FIG. 3 is a schematic diagram showing a comparison between light spots formed (e.g., on the light incident surface and the light outgoing surface of the diffractive optical element 6, respectively) before and after a light beam passes through the diffractive optical element 6. As shown in FIG. 3, the light beam emitted from each of the laser generators 5 has a light spot of a relatively small circle before entering into the diffractive optical element 6, but has a light spot of a relatively large rectangle after being subjected to shaping and expanding by the diffractive optical element 6. In this way, a distance between any two adjacent ones of the laser generators 5 may be increased properly, and thus the number of the laser generators 5 required in the light source 1A is decreased.

In a practical application, a position of each of the laser generators 5 may be adjusted properly to ensure the uniformity of light emitted from various regions of the light outgoing surface of the diffractive optical element 6. It should be noted that, the diffractive optical element 6 does not change polarization characteristics of the linearly polarized light emitted from the light source 1A.

In the backlight assembly provided by the embodiment of FIG. 2, it is not necessary to provide a light guide plate and an optical film such as a diffuser, a reflector, a prism sheet, or the like between the light source 1A and a liquid crystal display panel which is to cooperate with the backlight assembly (in other words, at the light outgoing side of the light source 1A).

The backlight assembly provided by the embodiment of FIG. 2 may further include a back cover 7, and the back cover 7 includes a bottom plate 7A and sidewalls 7B. The light source 1A is fixed to the bottom plate 7A, and a support member 10 may be provided on each of the sidewalls 7B. The diffractive optical element 6 may be fixed (e.g., by using a double-sided adhesive) to the support members 10, so that the support members 10 can support the diffractive optical element 6. In an embodiment, each of the support members 10 may be provided on both the bottom plate 7A and a corresponding sidewall 7B, i.e., provided at the corner where the bottom plate 7A and the corresponding sidewall 7B are connected to each other. In an embodiment, the bottom plate 7A and each of the sidewalls 7B are substantially perpendicular to each other.

The backlight assembly provided by the embodiment of FIG. 2 may further include a mold frame 8 and a bezel 9. The combination of the back cover 7, the mold frame 8, and the bezel 9 may fix the backlight assembly shown in FIG. 2 and a liquid crystal display panel which is to cooperate with the backlight assembly together, to form a liquid crystal display device (e.g., as shown in FIG. 4). The mold frame 8 and the bezel 9 shown in FIGS. 1 and 2 may be those known in the art, and detailed description thereof is omitted herein.

The embodiment of FIG. 2 provides the backlight assembly which may cooperate with a liquid crystal display panel. As described above, the backlight assembly includes the light source 1A configured to emit linearly polarized light polarized in a predetermined direction. In the technical solution of the present disclosure, the light source 1A is configured to emit linearly polarized light directly, and thus it is not necessary to provide the lower polarizer 4A at a side of a liquid crystal display panel which is to cooperate with the backlight assembly proximal to the light source 1A. As a result, a light transmittance of the liquid crystal display panel is increased. Further, the omission of a light guide plate and an optical film can further decrease a thickness of the liquid crystal display device, and further increase the light transmittance of the liquid crystal display device.

FIG. 4 is a schematic diagram showing a structure of another liquid crystal display device according to an embodiment of the present disclosure. As shown in FIG. 4, the liquid crystal display device includes a backlight assembly and a liquid crystal display panel 33. In an embodiment, the backlight assembly may be the backlight assembly provided by the embodiment of FIG. 2. Thus, detailed description of the backlight assembly may be referred to the foregoing description, and will not be repeated hereinafter.

In an embodiment, the liquid crystal display panel 33 includes a first substrate 11A and a second substrate 12 arranged opposite to each other, and the first substrate 11A is at a side of the second substrate 12 distal to the backlight assembly. The liquid crystal display panel 33 further includes a liquid crystal layer 13 provided between the first substrate 11A and the second substrate 12.

In an embodiment, the first substrate 11A includes a first base substrate 11′ (which may be the same as the first substrate 11 shown in FIG. 1) and a polarizer 44. The polarizer 44 may be at either a side of the first base substrate 11′ proximal to the second substrate 12 (i.e., an inner side of the first base substrate 11′, as shown in FIG. 4), or a side of the first base substrate 11′ distal to the second substrate 12 (i.e., an outer side of the first base substrate 11′). A polarization direction of the polarizer 44 may be perpendicular to the polarized direction of the linearly polarized light emitted from the light source 1A. It should be noted that, in the liquid crystal display panel 33 according to the present embodiment, no polarizer is provided at an outer side (i.e., a light incident side) or an inner side (i.e., a light outgoing side) of the second substrate 12. That is, the polarizer 4A as shown in FIG. 1 is omitted from the liquid crystal display device shown in FIG. 4.

In an embodiment, the first substrate 11A further includes a color conversion layer (which may also be referred to as a wavelength conversion layer) 14 provided at a side of the polarizer 44 distal to the light source 1A. The color conversion layer 14 may include a plurality of color conversion patterns (which may also be referred to as wavelength conversion patterns), and the plurality of color conversion patterns are configured to emit light of predetermined colors under excitation by the light emitted from the light source 1A, thereby achieving chromatic display. In an embodiment, the predetermined colors may be different from a color of the light emitted from the light source 1A.

In an embodiment, the liquid crystal display panel 33 includes a plurality of pixel regions, and the color conversion patterns are provided in at least some of the plurality of pixel regions. A grid line of a black matrix 19 separates any two adjacent ones of the pixel regions from each other.

In an embodiment, the liquid crystal display panel 33 includes first pixel regions 3a, second pixel regions 3b and third pixel regions 3c. The color conversion layer 14 may include first color conversion patterns (also referred to as first wavelength conversion patterns) 14a and second color conversion patterns (also referred to as second wavelength conversion patterns) 14b. Each of the first color conversion patterns 14a is provided in a corresponding one of the first pixel regions 3a, and configured to emit first color light under excitation by the light emitted from the light source 1A. Each of the second color conversion patterns 14b is provided in a corresponding one of the second pixel regions 3b, and configured to emit second color light under excitation by the light emitted from the light source 1A. The light emitted from the light source 1A is transmitted through the third pixel region 3c, so that the third pixel region 3c displays third color light.

In an embodiment, the light source 1A emits monochrome linearly polarized light, e.g., monochrome linearly polarized laser. The color conversion patterns can generate color light having good monochromaticity, thus the method of achieving chromatic display by combining monochromatic light with the color conversion patterns can achieve an extremely high color gamut, thereby increasing color representation capability of the liquid crystal display device.

In an embodiment, the linearly polarized light emitted from the light source 1A is blue light. Each of the first pixel regions 3a is a red pixel region, each of the second pixel regions 3b is a green pixel region, and each of the third pixel regions 3c is a blue pixel region. Each of the first color conversion patterns 14a is a red color conversion pattern, each of the second color conversion patterns 14b is a green color conversion pattern, and each of the third pixel regions 3c does not have a color conversion pattern provided therein (i.e., each of the third pixel regions 3c may be filled with air). The first color light emitted from each of the first pixel regions 3a emits is red light, the second color light emitted from each of the second pixel regions 3b is green light, and the third color light emitted from each of the third pixel regions 3c is blue light.

Taking one of the red pixel regions (e.g., one of the first pixel regions 3a) as an example, the blue linearly polarized light emitted from the light source 1A passes through the diffractive optical element 6, the second substrate 12, the liquid crystal layer 13, and the polarizer 44 sequentially, and then travels to the corresponding red color conversion pattern (e.g., the corresponding first color conversion pattern 14a). The red color conversion pattern emits red light under excitation by the blue light (i.e., the blue light is converted into red light). During this process, liquid crystal molecules in the red pixel region are controlled to deflect by an electric field generated by display electrodes located in the first substrate 11A and/or the second substrate 12, and then the blue linearly polarized light emitted from the light source 1A is subjected to the filtering effect of the polarizer 44, thereby controlling a display grayscale of the red pixel region. At the same time, the red color conversion pattern converts at least a portion of the received blue light into red light, thereby displaying red color.

The display principle for each of the green pixel regions (e.g., each of the second pixel regions 3b) is the same as the above display principle for each of the red pixel regions, and detailed description thereof is omitted herein. For each of the blue pixel regions (e.g., each of the third pixel regions 3c), similarly, liquid crystal molecules in the blue pixel region are controlled to deflect by an electric field generated by the display electrodes located in the first substrate 11A and/or the second substrate 12, and then the blue linearly polarized light emitted from the light source 1A is subjected to the filtering effect of the polarizer 44, thereby controlling a display grayscale of the blue pixel region. At the same time, since the blue pixel region is not provided with a color conversion pattern, the blue light emitted from the light source 1A exits from the blue pixel region without the wavelength of the blue light being changed, thereby displaying blue color.

In an embodiment, a material of each first color conversion pattern 14a or each second color conversion pattern 14b includes at least one of an inorganic material containing a rare earth element, an organic fluorescent material, and a quantum dot material. For example, a material of each of the first color conversion patterns 14a includes at least one of a red inorganic material containing a rare earth element, a red organic fluorescent material, and a red quantum dot material, and a material of each of the second color conversion patterns 14b includes at least one of a green inorganic material containing a rare earth element, a green organic fluorescent material, and a green quantum dot material.

The inventors of the present disclosure found in a practical application that, in a case where the light irradiating the first and/or second color conversion patterns 14a and 14b has a high brightness (i.e., in a case of high grayscale display), a portion of the light emitted from the light source 1A may not be absorbed and converted by the first and/or second color conversion patterns 14a and 14b, and thus is transmitted therethrough. As a result, the monochromaticity of the light exiting from the first and/or second pixel regions 3a and 3b is not high.

To solve the technical problem that the monochromaticity is not high, in an embodiment, a light absorbing layer 15 including light absorbing patterns 15a and 15b is provided at a side of the color conversion patterns distal to the light source 1A, and the light absorbing patterns 15a and 15b are configured to absorb the light emitted from the light source 1A and transmitted through the color conversion patterns (i.e., a portion of the light emitted from the light source 1A of which the wavelength is not converted by the color conversion patterns). Light emitted from the color conversion patterns (i.e., a portion of the light emitted from the light source 1A of which the wavelength is converted by the color conversion patterns) is transmitted through the light absorbing patterns.

In an embodiment, a first light absorbing pattern 15a is provided at a side of each of the first color conversion patterns 14a distal to the light source 1A, and configured to absorb the light emitted from the light source 1A and transmitted through the first color conversion pattern 14a. A second light absorbing pattern 15b is provided at a side of each of the second color conversion patterns 14b distal to the light source 1A, and configured to absorb the light emitted from the light source 1A and transmitted through the second color conversion pattern 14b. By providing the first light absorbing patterns 15a and the second light absorbing patterns 15b, the technical solution of the present disclosure can increase the monochromaticity of light emitted from the first pixel regions 3a and the second pixel regions 3b effectively.

Taking one of the first pixel regions 3a as an example, when the light (e.g., blue light) emitted from the light source 1A irradiates on the corresponding first color conversion pattern 14a, at least a portion of the light (e.g., blue light) is absorbed by the first color conversion pattern 14a and converted by the first color conversion pattern 14a into the first color light (e.g., red light), the remaining portion of the light (e.g., blue light) is transmitted through the corresponding first color conversion pattern 14a. In this case, the light (e.g., blue light) emitted from the light source 1A and transmitted through the corresponding first color conversion pattern 14a is absorbed by the corresponding first light absorbing pattern 15a, whereas the first color light (e.g., red light) generated by the corresponding first color conversion pattern 14a is transmitted through the corresponding first light absorbing pattern 15a, thereby ensuring the high monochromaticity of light emitted from the corresponding first pixel region 3a.

It should be noted that, both the first light absorbing patterns 15a and the second light absorbing patterns 15b may be made of a same material (e.g., a blue light absorbing material), since they are all configured to absorb the light emitted from the light source 1A. Further, since the light source 1 is configured to emit monochromatic light which has a very narrow waveband, and since most energy of the light is configured to excite the color conversion layer to generate light of new colors, a small amount of absorbing material capable of absorbing the light in the waveband emitted from the light source 1A and transmitted through the first and/or second color conversion patterns 14a and 14b may be applied. Compared with the color filter layer 16 of the liquid crystal display device shown in FIG. 1, the light absorbing layer 15 shown in FIG. 4 causes an absorption loss thereof to be decreased significantly, which is advantageous for increasing the light transmittance of the liquid crystal display device.

It should be noted that, it has been exemplified that the liquid crystal display panel 33 includes three types of pixel regions, the linearly polarized light emitted by the light source 1A is blue light, and the color conversion patterns include two types which are a red color conversion pattern and a green color conversion pattern in the foregoing description, however, the present disclosure is not limited thereto. The technical solutions of the present disclosure have no limitation to types of the pixel regions, types of the color conversion patterns, and a color of the light emitted from the light source, as long as the light emitted from the backlight assembly has a wavelength smaller than a critical wavelength of light emitted from the first color conversion pattern 14a and the second color conversion pattern 14b under excitation. For example, in a case of achieving four-color display scheme of red, green, yellow, and blue, the liquid crystal display panel 33 includes four types of pixel regions which are a red pixel region, a green pixel region, a yellow pixel region, and a blue pixel region, and the color conversion patterns include three types which are a red color conversion pattern, a green color conversion pattern, and a yellow color conversion pattern. The three types of color conversion patterns are located in the pixel regions of corresponding colors, and the blue pixel region may be a transparent structure or a hollowed-out structure (e.g., may be filled with air).

In an embodiment, the liquid crystal display panel 33 provided by the present disclosure may be a liquid crystal display panel of any display mode, such as a twisted nematic (TN) liquid crystal display panel, an in-plane switching (IPS) liquid crystal display panel, a fringe field switching (FFS) liquid crystal display panel, a vertical alignment (VA) liquid crystal display panel, an advanced super dimension switch (ADS) liquid crystal display panel, or the like.

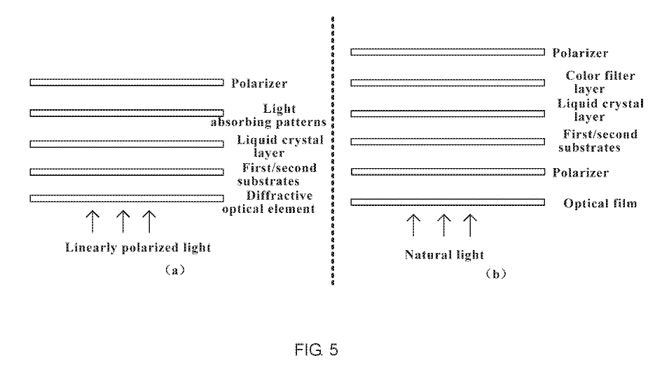

FIG. 5 is a schematic diagram showing a comparison between a light transmittance of a display assembly of the liquid crystal display device shown in FIG. 4 and a light transmittance of a display assembly of the liquid crystal display device shown in FIG. 1. As shown in FIG. 5, the “display assembly” herein refers to a collection of structures through which the light passes during propagating from the light source 1 or 1A to the a side of the liquid crystal display panel 3 or 33 distal to the light source 1 or 1A.

Portion (a) of FIG. 5 is a schematic diagram showing a light transmittance of main structures in the display assembly of the liquid crystal display device shown in FIG. 4. As shown in the portion (a) of FIG. 5, the diffractive optical element 6 has a light transmittance of about 95%, the first and second substrates 11A and 12 (excluding the polarizer 44, the color conversion layer and the light absorbing layer) have a light transmittance of about 70%, the liquid crystal layer 13 has a light transmittance of about 85%, the color conversion layer and the light absorbing layer have a light transmittance of about 60%, and the polarizer 44 of the first substrate 11A has a light transmittance of about 92%, by multiplying the above light transmittances by each other, an overall light transmittance of 31.2% of the display assembly is obtained.

Portion (b) of FIG. 5 is a schematic diagram showing a light transmittance of main structures in the display assembly of the liquid crystal display device shown in FIG. 1. As shown in the portion (b) of FIG. 5, the optical film 2 has a light transmittance of about 80%, the polarizer 4A at the light incident side of the second substrate 12 has a light transmittance of about 43%, the first and second substrates 11 and 12 have a light transmittance of about 70%, the liquid crystal layer 13 has a light transmittance of about 85%, the color filter layer 16 has a light transmittance of about 30% and the polarizer 4B at the light outgoing side of the first substrate 11 has a light transmittance of about 92%, by multiplying the above light transmittances by each other, an overall light transmittance of 5.6% of the display assembly is obtained.

From the above description it can be seen that, compared with the technical solution shown in FIG. 1, the technical solution corresponding to FIG. 4 can increase an overall light transmittance of the display assembly of the liquid crystal display device, thereby increasing the display brightness of the liquid crystal display device.

In the liquid crystal display device provided by any one of the embodiments of the present disclosure, the light source is configured to emit linearly polarized light directly, and thus it is not necessary to provide a polarizer at a side of the liquid crystal display panel proximal to the light source, thereby decreasing a thickness of the liquid crystal display panel effectively. Further, the omission of a polarizer can increase a light transmittance of the liquid crystal display panel. Further, chromatic display is achieved by combining monochromatic light emitted from the light source with the color conversion patterns provide in the liquid crystal display panel, thereby achieving advantageous display effects such as high brightness, wide color gamut, and the like.

It should be understood that, the above embodiments are only exemplary embodiments for the purpose of explaining the principle of the present disclosure, and the present disclosure is not limited thereto. For one of ordinary skill in the art, various improvements and modifications may be made without departing from the spirit and essence of the present disclosure. These improvements and modifications also fall within the protection scope of the present disclosure.

What is claimed is:

1. A backlight assembly, comprising a light source, wherein the light source is configured to emit linearly polarized light polarized in a first direction.

2. The backlight assembly according to claim 1, wherein the light source comprises a plurality of laser generators arranged in an array.

3. The backlight assembly according to claim 2, wherein the linearly polarized light is linearly polarized laser.

4. The backlight assembly according to claim 1, wherein the linearly polarized light emitted from the light source is monochromatic light.

5. The backlight assembly according to claim 1, further comprising a diffractive optical element provided at a light outgoing side of the light source.

6. The backlight assembly according to claim 5, wherein a light outgoing surface of the diffractive optical element comprises a micro-nano diffraction structure.

7. The backlight assembly according to claim 5, wherein a light incident surface of the diffractive optical element has a transmission enhanced layer provided thereon.

8. The backlight assembly according to claim 2, wherein each of the plurality of laser generators is a monochrome linearly polarized laser generator.

9. The backlight assembly according to claim 8, wherein the linearly polarized light emitted from the light source is monochrome linearly polarized laser.

10. The backlight assembly according to claim 8, wherein each of the plurality of laser generators is a blue linearly polarized laser generator.

11. The backlight assembly according to claim 10, wherein the linearly polarized light emitted from the light source is blue linearly polarized laser.

12. The backlight assembly according to claim 5, further comprising a back cover and a support member, wherein the back cover comprises a bottom plate and a sidewall, the light source is provided on the bottom plate, and the support member is provided on the sidewall and configured to support the diffractive optical element.

13. A liquid crystal display device, comprising a backlight assembly and a liquid crystal display panel, wherein the backlight assembly is the backlight assembly according to claim 1.

14. The liquid crystal display device according to claim 13, wherein the liquid crystal display panel comprises a first substrate and a second substrate arranged opposite to each other, the first substrate is at a side of the second substrate distal to the backlight assembly, and a liquid crystal layer is provided between the first substrate and the second substrate; and
the first substrate comprises a polarizer.

15. The liquid crystal display device according to claim 14, wherein the first substrate further comprises a color conversion layer provided at a side of the polarizer distal to the light source; and
the color conversion layer comprises color conversion patterns configured to emit light of a color different from a color of the light emitted from the light source, under excitation by the light emitted from the light source.

16. The liquid crystal display device according to claim 15, wherein the liquid crystal display panel comprises a plurality of pixel regions, and the color conversion patterns are provided in at least some of the plurality of pixel regions.

17. The liquid crystal display device according to claim 16, wherein the plurality of pixel regions comprise a first pixel region, a second pixel region, and a third pixel region;
the color conversion patterns comprise a first color conversion pattern and a second color conversion pattern;
the first color conversion pattern is provided in the first pixel region, and configured to emit first color light under excitation by the light emitted from the light source;
the second color conversion pattern is provided in the second pixel region, and configured to emit second color light under excitation by the light emitted from the light source; and
the light emitted from the light source is transmitted through the third pixel region without its wavelength being changed.

18. The liquid crystal display device according to claim 17, wherein the linearly polarized light emitted from the light source is blue light, the first pixel region is a red pixel region, the second pixel region is a green pixel region, and the third pixel region is a blue pixel region; and
the first color light is red light, and the second color light is green light.

19. The liquid crystal display device according to claim 15, wherein a material of the color conversion patterns comprises at least one of an inorganic material containing a rare earth element, an organic fluorescent material, and a quantum dot material.

20. The liquid crystal display device according to claim 15, further comprising light absorbing patterns provided at a side of the color conversion patterns distal to the light source, wherein the light absorbing patterns are configured to absorb the light emitted from the light source and transmitted through the color conversion patterns, whereas light converted by the color conversion patterns is transmitted through the light absorbing patterns.
